(19) United States
(12) Patent Application Publication
(10) Pub. No.: US 2026/0277269 A1
(43) Pub. Date: Sep. 17, 2026

(54) DISPLAY MODULE AND DISPLAY DEVICE

(71) Applicants: Beijing BOE Display Technology Co., Ltd., Beijing (CN); BOE TECHNOLOGY GROUP CO., LTD., Beijing (CN)

(72) Inventors: Yujia Zhang, Beijing (CN); Qian Cheng, Beijing (CN); Hetao Wang, Beijing (CN); Chunlei Xiao, Beijing (CN); Jingrui Ren, Beijing (CN); Zhengyan Wan, Beijing (CN)

(73) Assignees: Beijing BOE Display Technology Co., Ltd., Beijing (CN); BOE TECHNOLOGY GROUP CO., LTD., Beijing (CN)

(21) Appl. No.: 19/471,790

(22) PCT Filed: May 27, 2024
(86) PCT No.: PCT/CN2024/095595

§ 371 Date: Oct. 2, 2025

(30) Foreign Application Priority Data
May 26, 2023 (CN) 202310610143.3

(51) Int. Cl. G06F 1/16

(52) U.S. Cl. CPC G06F 1/1607

(57) ABSTRACT

A display module and a display device relate to the technical field of displaying. The display module includes a plurality of display panels (11) and a middle frame (12), the plurality of display panels are tightly spliced; and the middle frame is disposed away from light-emitting surfaces of the plurality of display panels, and the plurality of display panels are fixedly connected to a same middle frame (12).

### CROSS-REFERENCE TO RELATED APPLICATION

The present application claims the priority of the Chinese patent application filed on May 26, 2023 before the China National Intellectual Property Administration with the application number of 202310610143.3 and the title of “DISPLAY MODULE AND DISPLAY DEVICE”, which is incorporated herein in its entirety by reference.

### FIELD

The present application relates to the technical field of displaying and, more particularly, to a display module and a display device.

### BACKGROUND

In the application scenarios of central control displaying, splicing displaying, a security desktop monitor, etc., a way of placing multiple ordinary displays side by side is mostly adopted in related art.

### SUMMARY

A display module is provided by the present application, which includes:
a plurality of display panels, the plurality of display panels being tightly spliced; and
a middle frame disposed away from light-emitting surfaces of the plurality of display panels;
wherein the plurality of display panels are fixedly connected to a same middle frame.

In some embodiments, the middle frame includes:
a support structure located at a splicing gap between two adjacent display panels, wherein a side of the support structure close to the two adjacent display panels is fixedly connected to the two adjacent display panels, respectively;
the display module further includes at least one of:
an optical film located at a side of the middle frame away from the two adjacent display panels; and
a light guide plate located at a side of the optical film away from the two adjacent display panels.

In some embodiments, the support structure includes:
a first support structure including a first support plate and a second support plate, wherein the first support plate is disposed close to the two adjacent display panels, the second support plate is connected to a side surface of the first support plate away from the two adjacent display panels, and in an arrangement direction of the two adjacent display panels, the second support plate is centrally disposed on the first support plate, and the first support plate and the second support plate are perpendicular to each other.

In some embodiments, the optical film is provided with an opening, and an orthographic projection of the second support plate on a plane where the optical film is located is located within a region of the opening, so that the opening is configured to avoid the second support plate.

In some embodiments, in the arrangement direction of the two adjacent display panels, a first gap is disposed between the second support plate and a hole wall of the opening.

In some embodiments, in a normal direction of the plurality of display panels, a second gap is disposed between the second support plate and the light guide plate;
an orthographic projection of the first support plate on the plane where the optical film is located overlaps with the optical film, and in the normal direction of the plurality of display panels, a third gap is disposed between the first support plate and the optical film;
wherein the second gap is less than or equal to the third gap.

In some embodiments, in an extending direction of the splicing gap, the support structure includes a plurality of first support structures spaced apart from each other.

In some embodiments, the support structure further includes:
a second support structure including a third support plate, wherein the third support plate is parallel to and connected to the first support plate; and
in an extending direction of the splicing gap, the second support structure is located at two sides of the first support structure.

In some embodiments, in a normal direction of the plurality of display panels, a thickness of the third support plate is the same as a thickness of the first support plate;
in the arrangement direction of the two adjacent display panels, a width of the third support plate is the same as a width of the first support plate; and
the first support plate, the second support plate, and the third support plate are of an integrated structure.

In some embodiments, each of the plurality of display panels includes a display region and a non-display region located at at least one side of the display region, and an orthographic projection of the support structure on the display panel does not overlap with the display region; and
in an arrangement direction of the two adjacent display panels, a fifth gap is disposed between the orthographic projection of the support structure on the display panel and the display region.

In some embodiments, the display module further includes:
a polarizer located at a side of the two adjacent display panels close to the support structure, wherein in a normal direction of the plurality of display panels, a sixth gap is disposed between the polarizer and the optical film, and the sixth gap is greater than or equal to 1.0 mm.

In some embodiments, the display module further includes:
a polarizer located at a side of the two adjacent display panels close to the support structure, wherein an orthographic projection of the polarizer on the two adjacent display panels and an orthographic projection of the support structure on the two adjacent display panels have an overlapping region; and
an edge of a side surface of the support structure close to the two adjacent display panels is provided with a concave platform, the concave platform is recessed away from the polarizer, wherein in an arrangement direction of the two adjacent display panels, a width of the concave platform is greater than a width of the overlapping region, and in a normal direction of the plurality of display panels, a height of the concave platform is greater than or equal to a thickness of the polarizer.

In some embodiments, the middle frame further includes:
a frame structure located around the support structure and the plurality of display panels, wherein the frame structure and the support structure are an interconnected integrated structure.

In some embodiments, the frame structure includes a first frame structure and a second frame structure located at different sides of the support structure, and the display module further includes:
a first light-shielding tape adhered between the first frame structure and the two adjacent display panels;
a second light-shielding tape adhered between the second frame structure and the two adjacent display panels;
a third light-shielding tape adhered between the support structure and the two adjacent display panels;
wherein a width of the third light-shielding tape is greater than or equal to a width of the second light-shielding tape, and the width of the second light-shielding tape is greater than or equal to a width of the first light-shielding tape.

In some embodiments, the display module further includes at least one of:
a back plate disposed at a side of the middle frame away from the plurality of display panels, wherein a surface of the back plate away from the plurality of display panels includes a functional region and a non-functional region;
a rear cover located at a side of the functional region away from the plurality of display panels, wherein an accommodating space is disposed between the rear cover and the functional region, and the accommodating space is configured to dispose at least one of: a card, a system on chip, and a connecting structure; and
an insulation protection layer located in the non-functional region and not overlapping with the functional region.

In some embodiments, the display module further includes:
a chip on film connected to a bonding region of each of the plurality of display panels; and
a front frame disposed close to the light-emitting surfaces of the plurality of display panels, wherein an orthographic projection of the front frame on the plurality of display panels covers an orthographic projection of the chip on film on the plurality of display panels.

In some embodiments, each of the plurality of display panels is a borderless display panel, and edges of the display panel are coated with a black adhesive.

A display device is provided by the present application, which includes:
the display module according to any one of embodiments stated above; and
a driving component connected to the plurality of display panels and configured to provide driving signals to the plurality of display panels.

The above description is only a summary of technical schemes of the present application, which can be implemented according to contents of the specification in order to better understand technical means of the present application; and in order to make above and other objects, features and advantages of the present application more obvious and understandable, specific implementations of the present application are particularly provided in the following.

### BRIEF DESCRIPTION OF THE DRAWINGS

In order to more clearly illustrate the technical solutions of the embodiments of the present application or the related art, the figures that are required to be used to describe the embodiments or the related art may be briefly introduced below. Apparently, the figures that are described below are some embodiments of the present application, and a person skilled in the art can obtain other figures according to these figures without paying any creative work. It should be noted that the proportions in the drawings are only indicative and do not represent actual proportions.

FIG. 1 exemplarily shows a schematic view of a cross-sectional structure of a display module at a first position;

FIG. 2 exemplarily shows a schematic view of a cross-sectional structure of a display module at a second position;

FIG. 3a is a schematic view of a plane structure at a light-emitting side of a middle frame;

FIG. 3b is a schematic view of a plane structure at a backlight side of a middle frame;

FIG. 3c is a partial enlarged view of a dashed box in FIG. 3b;

FIG. 4a shows a schematic view of a cross-sectional structure of a left-side frame of a display module;

FIG. 4b shows a schematic view of a cross-sectional structure of a right-side frame of the display module;

FIG. 4c shows a schematic view of a cross-sectional structure of an upper-side frame of the display module;

FIG. 4d shows a schematic view of a cross-sectional structure of a lower-side frame of the display module;

FIG. 5 exemplarily shows a back image of a back plate;

FIG. 6 exemplarily shows a back image of a display module;

FIG. 7 exemplarily shows a front local image of a display module;

FIG. 8 exemplarily shows a schematic diagram of a dual-screen display module;

FIG. 9 exemplarily shows a schematic diagram of a triple-screen display module; and

FIG. 10 exemplarily shows a schematic diagram of a six-screen display module.

### DETAILED DESCRIPTION

In order to make the objects, the technical solutions and the advantages of the embodiments of the present application clearer, the technical solutions of the embodiments of the present application may be clearly and completely described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying any creative work fall within the protection scope of the present application.

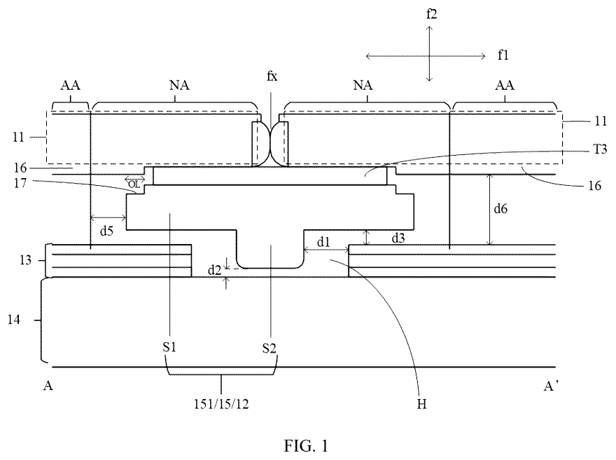

Referring to FIG. 1, FIG. 1 exemplarily shows a schematic structural diagram of a display module according to the present application. As shown in FIG. 1, the display module includes: a plurality of display panels 11 and a middle frame 12, the plurality of display panels 11 are tightly spliced; and the middle frame 12 is disposed away from light-emitting surfaces of the plurality of display panels 11; wherein the plurality of display panels 11 are fixedly connected to a same middle frame 12. Here, the tight spliced means that the display panels 11 are physically arranged on a plane. There is only a gap with a negligible size between the adjacent display panels 11.

By tightly splicing the plurality of display panels 11 onto the same middle frame 12, the boundaries of the display panels 11 can be weakened, the sense of fragmentation can be reduced, the aesthetic measure and portability of the display module can be improved, the structural complexity degree of the display module can be simplified, and it becomes easier for customers to design and install the whole machine. Compared to solutions of attaching the plurality of display panels 11 to the same cover plate, the display module provided by the present application is thinner in thickness, lighter in weight, and higher in brightness, and can also simplify the assembly process, improve production efficiency, and reduce costs.

Additionally, in the display module provided by the present application, mass-produced display panels 11 can be used without re-developing the mask, the development cycle is shortened and the cost is reduced.

The display module provided by the present application has a display effect similar to a display effect of a bar-shaped screen and can be applied in scenarios such as central control displaying, splicing displaying, a security desktop monitor, to meet display requirements of the customers for special-shaped screens and special application scenarios.

The middle frame 12 plays a role in fixing and protecting the display panels 11, can be made of plastic materials such as polycarbonate, and can also be made of metal materials. The middle frame 12 of the polycarbonate material has high strength and good appearance effect, which is convenient for customers to design the whole machine. In addition, the middle frame 12 of the black polycarbonate material may play a role in preventing light leakage at the edge of the display panel 11.

In some embodiments, as shown in FIG. 1, the display module may further include: an optical film 13 located at a side of the middle frame 12 away from the two adjacent display panels 11.

Exemplarily, the optical film 13 may include one or more films such as a diffuser sheet, a prism sheet, and a brightness enhancement film, which is not limited in the present application.

In some embodiments, as shown in FIG. 1, the display module may further include: a light guide plate 14 located at a side of the optical film 13 away from the two adjacent display panels 11. The light guide plate 14 plays a role in homogenizing light.

In some embodiments, as shown in FIGS. 1 to 3c, the middle frame 12 includes: a support structure 15 located at a splicing gap fx between two adjacent display panels 11, wherein a side of the support structure 15 close to the two adjacent display panels 11 is fixedly connected to the two adjacent display panels 11, respectively.

In the present embodiment, the support structure 15 is used to fixedly support the two adjacent display panels 11 while also preventing light leakage at the splicing gap fx between the two adjacent display panels 11.

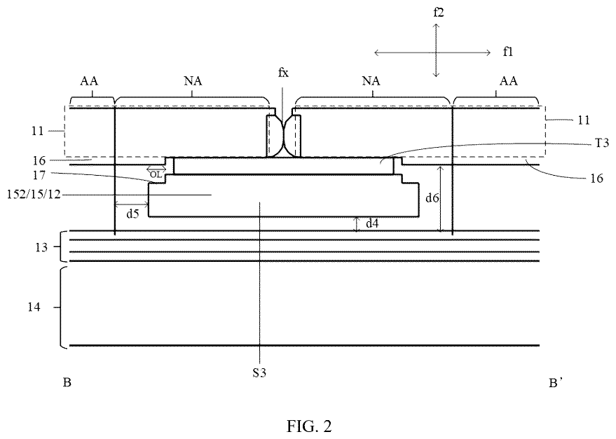

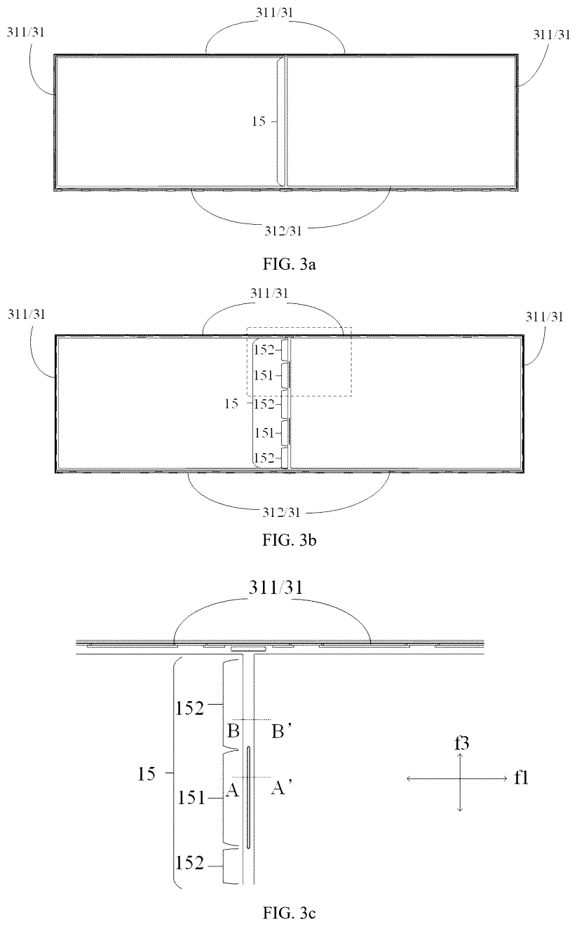

FIG. 3a is a schematic view of a plane structure at the light-emitting side of a middle frame, FIG. 3b is a schematic view of a plane structure at the backlight side of a middle frame, and FIG. 3c is a partial enlarged view of the dashed box in FIG. 3b. FIG. 1 is a schematic view of a cross-sectional structure of a display module along the AA′, and FIG. 2 is a schematic view of a cross-sectional structure of a display module along the BB′.

During specific implementation, the support structure 15 may be positioned at the splicing gap fx between any two adjacent display panels 11. The extending direction f3 of the splicing gap may, for example, be perpendicular to the arrangement direction f1 of the two adjacent display panels 11, as shown in FIG. 3a to FIG. 3c.

In some embodiments, as shown in FIG. 3a to FIG. 3c, the support structure 15 includes a first support structure 151. As shown in FIG. 1, the first support structure 151 includes a first support plate S1 and a second support plate S2. The first support plate S1 is disposed close to the two adjacent display panels 11, and the second support plate S2 is connected to a side surface of the first support plate S1 away from the two adjacent display panels 11. In the arrangement direction f1 of the two adjacent display panels, the second support plate S2 is centrally disposed on the first support plate S1, and the first support plate S1 and the second support plate S2 are perpendicular to each other.

As shown in FIG. 1, in the arrangement direction f1 of the two adjacent display panels 11, a size of the first support plate S1 is greater than a size of the second support plate S2. In this way, the impact of the second support plate S2 on the optical film 13 may be reduced.

Exemplarily, in the arrangement direction f1 of the two adjacent display panels 11, the width of the first support plate S1 is greater than or equal to 2 mm and less than or equal to 10 mm, the width of the second support plate S2 is greater than or equal to 1 mm and less than or equal to 2 mm. For example, in FIG. 1, the width of the first support plate S1 is 6.4 mm, and the width of the second support plate S2 is 1.5 mm.

During specific implementation, a shape of the first cross section of the first support structure 151 may be T-shaped (as shown in FIG. 1), or I-shaped, etc., which is not limited by the present application. The first cross-section is parallel to a normal direction f2 of the plurality of display panels 11 and the arrangement direction f1 of the two adjacent display panels 11.

In some embodiments, as shown in FIG. 1, the optical film 13 is provided with an opening H, and an orthographic projection of the second support plate S2 on a plane where the optical film 13 is located is located within a region of the opening H. The opening H is used to avoid the second support plate S2.

In practical applications, that the external force is applied to the display panel 11, or the display module is tilted backward, may cause the first support structure 151 to move down. By setting the opening H on the optical film 13, the first support structure 151 can be avoided to squeeze the optical film 13 during the downward movement to lead to problems such as the occurrence of sheet-like folds of the optical film 13.

In some embodiments, as shown in FIG. 1, in the arrangement direction f1 of the two adjacent display panels 11, a first gap d1 is disposed between the second support plate S2 and a hole wall of the opening H. By reserving the first gap d1 between the second support plate S2 and the hole wall of the opening H, it can be ensured that the optical film 13 may not be subjected to contact or squeeze from the second support plate S2 at the side of t optical film 13 after undergoing high-temperature expansion, thus the problem of the occurrence of sheet-like folds is avoided.

Exemplarily, the first gap d1 may be greater than or equal to 0.45 mm and less than or equal to 1.3 mm, such as the 1.0 mm shown in FIG. 1.

In some embodiments, as shown in FIG. 1, in the normal direction f2 of the plurality of display panels 11, a second gap d2 is disposed between the second support plate S2 and the light guide plate 14.

In some embodiments, as shown in FIG. 1, an orthographic projection of the first support plate S1 on the plane where the optical film 13 is located overlaps with the optical film 13, and in the normal direction f2 of the plurality of display panels 11, a third gap d3 is disposed between the first support plate S1 and the optical film 13. By reserving the third gap d3 between the first support plate S1 and the optical film 13, the problem that the first support structure 151 squeezes the optical film 13 during downward movement to result in the occurrence of the sheet-like folds of the optical film 13 may be avoided.

In some embodiments, the second gap d2 is less than or equal to the third gap d3.

When the display module is tilted backward or the surface of the display panel 11 is subjected to external forces, the first support structure 151 below the splicing gap fx moves or deforms toward the light guide plate 14. When the movement amount or deformation amount reaches the second gap d2, the light guide plate 14 can withstand the second support plate S2, thus further movement or deformation of the first support structure 151 is prevented. By setting a smaller second gap d2, the anti-deformation capability of the first support structure 151 may be enhanced.

Since the third gap d3 is greater than the second gap d2, when the light guide plate 14 withstands the second support plate S2, the first support plate S1 will not contact or press against the optical film 13, thus brightness non-uniformity caused by film folds is prevented. When the movement amount is large or deformation is severe, the second support plate S2 can promptly contact the light guide plate 14 for support while also ensuring that there is still a certain distance between the first support plate S1 and the optical film 13 to avoid the contact between the first support plate S1 and the optical film 13.

Exemplarily, the second gap d2 may be greater than or equal to 0.15 mm and less than or equal to 0.25 mm, such as the 0.195 mm shown in FIG. 1.

Exemplarily, the third gap d3 may be greater than or equal to 0.2 mm and less than or equal to 0.4 mm, such as the 0.33 mm shown in FIG. 1.

In some embodiments, as shown in FIG. 3a to FIG. 3c, in an extending direction f3 of the splicing gap, the support structure 15 includes a plurality of first support structures 151 spaced apart from each other.

By arranging the plurality of first support structures 151 below the splicing gap fx, the support effect of the support structure 15 may be strengthened, the rigidity of the middle frame (adhesive frame) is enhanced, and light leakage is prevented.

In some embodiments, as shown in FIG. 3a to FIG. 3c, the support structure 15 further includes a second support structure 152. In the extending direction f3 of the splicing gap, the second support structure 152 is located at two sides of the first support structure 151. As shown in FIG. 2, the second support structure 152 includes a third support plate S3, and the third support plate S3 is parallel to and connected to the first support plate S1.

Since the optical film below the first support structure 151 is provided with the opening H, an opening may not be disposed on the optical film below the second support structure 152. Therefore, by disposing the second support structure 152 at two sides of the first support structure 151 along the extending direction f3 of the splicing gap, it may be ensured that the optical films below the two adjacent display panels 11 is of an interconnected integrated structure, facilitating the fixation of the optical film 13.

Exemplarily, as shown in FIG. 3a to FIG. 3c, the support structure 15 includes two first support structures 151 and three second support structures 152. In the extending direction f3 of the splicing gap, the two first support structures 151 and the three second support structures 152 are arranged in the order of the second support structure 152, the first support structure 151, the second support structure 152, the first support structure 151, and the second support structure 152.

In some embodiments, as shown in FIG. 3a to FIG. 3c, in the extending direction f3 of the splicing gap, a size of the second support structure 152 closer to a center of the splicing gap fx is greater than a size of the second support structure 152 closer to an edge of the splicing gap fx. The size of the second support structure 152 closer to the center of the splicing gap fx is greater than the size of the first support structure 151 closer to the edge of the splicing gap fx. The size of the first support structure 151 closer to the center of the splicing gap fx is greater than the size of the second support structure 152 closer to the edge of the splicing gap fx. The size of the first support structure 151 closer to the center of the splicing gap fx is greater than the size of the first support structure 151 closer to the edge of the splicing gap fx. That is to say, the size of the first or second support structure closer to the center of the splicing gap fx is greater than the size of the first or second support structure closer to the edge of the splicing gap fx.

Exemplarily, in the extending direction f3 of the splicing gap, the size of the first support structure 151 may be greater than or equal to 10 mm and less than or equal to 100 mm, and the size of the second support structure 152 may be greater than or equal to 10 mm and less than or equal to 100 mm.

For example, in FIG. 3 a to FIG. 3 c, the size of the display panel is 298 mm×528.3 mm, and the size of the splicing gap fx is 298 mm. In the extending direction f3 of the splicing gap, the sizes of the second support structure 152, the first support structure 151, the second support structure 152, the first support structure 151, and the second support structure 152 that are sequentially arranged are 54 mm, 60 mm, 70 mm, 60 mm, and 54 mm, respectively.

In some embodiments, as shown in FIGS. 1 and 2, in a normal direction f2 of the plurality of display panels 11, the thickness of the third support plate S3 is the same as the thickness of the first support plate S1.

Exemplarily, in FIGS. 1 and 2, in the normal direction f2 of the plurality of display panels 11, the thickness of the third support plate S3 and the thickness of the first support plate S1 are greater than or equal to 0.8 mm and less than or equal to 2 mm. For example, in FIGS. 1 and 2, both of the thickness of the third support plate S3 and the thickness of the first support plate S1 are 1.23 mm.

Exemplarily, in the normal direction f2 of the plurality of display panels 11, a total thickness of the first support plate S1 and the second support plate S2 may be greater than or equal to 1.5 mm and less than or equal to 2.5 mm. For example, in FIG. 1, the total thickness of the first support plate S1 and the second support plate S2 is 1.85 mm.

As shown in FIG. 2, the orthographic projection of the third support plate S3 on the plane where the optical film 13 is located overlaps with the optical film 13, and in the normal direction f2 of the plurality of display panels 11, a fourth gap d4 is disposed between the third support plate S3 and the optical film 13. By disposing the fourth gap d4 between the third support plate S3 and the optical film 13, the problem that the second support structure 152 squeezes the optical film 13 during downward movement to result in the occurrence of the sheet-like folds of the optical film 13 may be avoided.

Exemplarily, the fourth gap d4 may be equal to the third gap d3.

Exemplarily, the fourth gap d4 may be greater than or equal to 0.2 mm and less than or equal to 0.4 mm. As shown in FIGS. 1 and 2, both the fourth gap d4 and the third gap d3 are 0.33 mm.

In some embodiments, as shown in FIGS. 1 and 2, in the arrangement direction f1 of the two adjacent display panels 11, a width of the third support plate S3 is the same as a width of the first support plate S1.

Exemplarily, in FIGS. 1 and 2, in the arrangement direction f1 of the two adjacent display panels 11, the width of the third support plate S3 may be greater than or equal to 2 mm and less than or equal to 10 mm. For example, in FIGS. 1 and 2, both of the width of the third support plate S3 and the width of the first support plate S1 are 6.4 mm.

In some embodiments, as shown in FIG. 3a to FIG. 3c, the first support plate S1, the second support plate S2, and the third support plate S3 are of an integrated structure. In this way, the first support plate S1, the second support plate S2, and the third support plate S3 may be integrally formed, and the assembly process may be simplified.

In some embodiments, as shown in FIG. 1 or FIG. 2, each of the plurality of display panels 11 includes a display region AA and a non-display region NA located at at least one side of the display region AA. An orthographic projection of the support structure 15 on the display panel 11 does not overlap with the display region AA, that is, the orthographic projection of the support structure 15 on the display panel 11 is located within the non-display region NA.

In some embodiments, in an arrangement direction f1 of the two adjacent display panels 11, a fifth gap d5 is disposed between the orthographic projection of the support structure 15 on the display panel 11 and the display region AA.

The inventor found that if the fifth gap d5 is too large, it is prone to cause backlight hot spot phenomenon and light leakage phenomenon. Therefore, in order to prevent the backlight hot spot phenomenon and light leakage problem, the fifth gap d5 should be minimized as much as possible. At the same time, it is necessary to avoid the problems of miss line and shadow caused by the support structure 15 covering the display region AA due to too small fifth gap d5 and the assembly error.

Exemplarily, the fifth gap d5 may be greater than or equal to 0.6 mm and less than or equal to 0.9 mm. For a 23.8-inch display panel 11, a fifth gap d5 is of, for example, 0.796 mm, and image quality can be ensured.

In some embodiments, as shown in FIG. 1 or FIG. 2, the display module further includes a polarizer 16 located at a side of the two adjacent display panels 11 close to the support structure 15. In a normal direction f2 of the two adjacent display panels 11, a sixth gap d6 is disposed between the polarizer 16 and the optical film 13, and the sixth gap d6 is greater than or equal to 1.0 mm. In this way, that the optical film 13 and the polarizer 16 do not scratch each other may be ensured.

Exemplarily, the sixth gap d6 may be greater than or equal to 1.2 mm and less than or equal to 3.0 mm. As shown in FIGS. 1 and 2, the sixth gap d6 is 1.563 mm.

In some embodiments, as shown in FIG. 1 or FIG. 2, the orthographic projection of the support structure 15 on the two adjacent display panels 11 and the orthographic projection of the polarizer 16 on the two adjacent display panels 11 have an overlapping region OL. The edge of a side surface of the support structure 15 close to the two adjacent display panels 11 is provided with a concave platform 17, the concave platform 17 is recessed away from the polarizer 16. In an arrangement direction f1 of the two adjacent display panels 11, a width of the concave platform 17 is greater than a width of the overlapping region OL. In the normal direction of the plurality of display panels 11, a height (i.e., a depth of the recess of the concave platform 17) of the concave platform 17 is greater than or equal to the thickness of the polarizer 16, thus the support structure 15 can be prevented from scratching the polarizer 16.

In some embodiments, as shown in FIG. 3a to FIG. 3c, the middle frame 12 further includes a frame structure 31 located around the support structure 15 and the plurality of display panels 11. The frame structure 31 and the support structure 15 are an interconnected integrated structure.

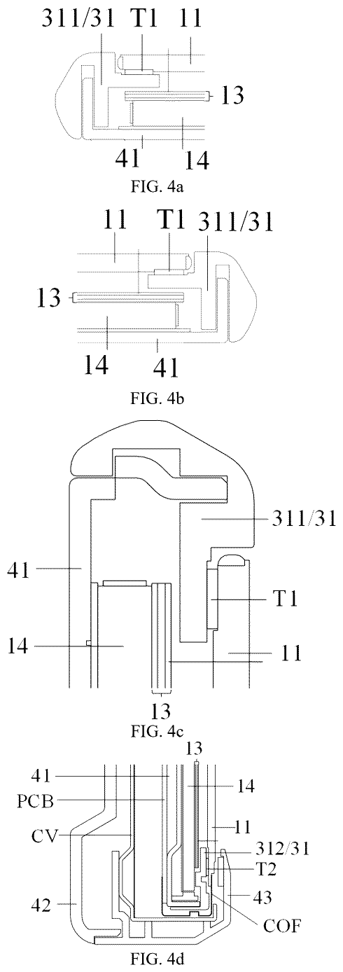

In some embodiments, as shown in FIG. 3a to FIG. 3c, the frame structure 31 includes a first frame structure 311 and a second frame structure 312 located at different sides of the support structure 15. The display module further includes: a first light-shielding tape T1 adhered between the first frame structure 311 and the two adjacent display panels 11, as shown in FIG. 4a to FIG. 4d; a second light-shielding tape T2 adhered between the second frame structure 312 and the two adjacent display panels 11, as shown in FIG. 4a to FIG. 4d; and a third light-shielding tape T3 adhered between the support structure 15 and the display panel 11, as shown in FIG. 1 or FIG. 2.

By using the first light-shielding tape T1, the second light-shielding tape T2, and the third light-shielding tape T3, the plurality of display panels 11 are fixed to the middle frame 12, the display panels 11 may be prevented from being deformed by the pull of the backlight module, light leakage can be prevented, and light leakage at the splicing gap fx and edges of the display panels 11 is prevented.

Exemplarily, the first light-shielding tape T1, the second light-shielding tape T2, and the third light-shielding tape T3 may be black foam double-sided adhesive tapes, such as 0.4 T black foam double-sided adhesive tapes.

In some embodiments, a width of the third light-shielding tape T3 is greater than or equal to a width of the second light-shielding tape T2, and the width of the second light-shielding tape T2 is greater than or equal to a width of the first light-shielding tape T1.

Here, the width of the third light-shielding tape T3 refers to a size of the third light-shielding tape T3 in the arrangement direction f1 of the two adjacent display panels 11. The width of the second light-shielding tape T2 is a distance between an inner edge of the second light-shielding tape T2 and an outer edge of the second light-shielding tape T2, and the width of the first light-shielding tape T1 is a distance between an inner of the first light-shielding tape T1 and an outer edge of the first light-shielding tape T1. The inner edge of the tape is the edge of the tape closer to the display panel 11, the outer edge of the tape is the edge of the tape farther away from the display panel 11.

Exemplarily, the width of the first light-shielding tape T1 is greater than or equal to 1.5 mm and less than or equal to 2.5 mm; the width of the second light-shielding tape T2 is greater than or equal to 2.5 mm and less than or equal to 3.5 mm; and the width of the third light-shielding tape T3 is greater than or equal to 3.5 mm and less than or equal to 6.5 mm.

For example, the width of the first light-shielding tape T1 is 2.2 mm, the width of the second light-shielding tape T2 is 3.0 mm, and the width of the third light-shielding tape T3 is 5.0 mm.

By setting a wider light-shielding tape (i.e., the third light-shielding tape T3) at the splicing gap fx of the display panel 11, the anti-deformation capability of the display panel 11 can be improved, and light leakage is reduced. By setting the width of the second light-shielding tape T2 to be greater than the width of the first light-shielding tape T1, components such as the chip on film (COF) can be disposed at the side closer to the second frame structure 312, thus components such as the chip on film (COF) is prevented from being visible.

Exemplarily, as shown in FIG. 3a to FIG. 3c, the second frame structure 312 is the frame structure 31 located at the lower side, while the first frame structure 311 is the frame structure 31 located at the left side, the right side, or the upper side.

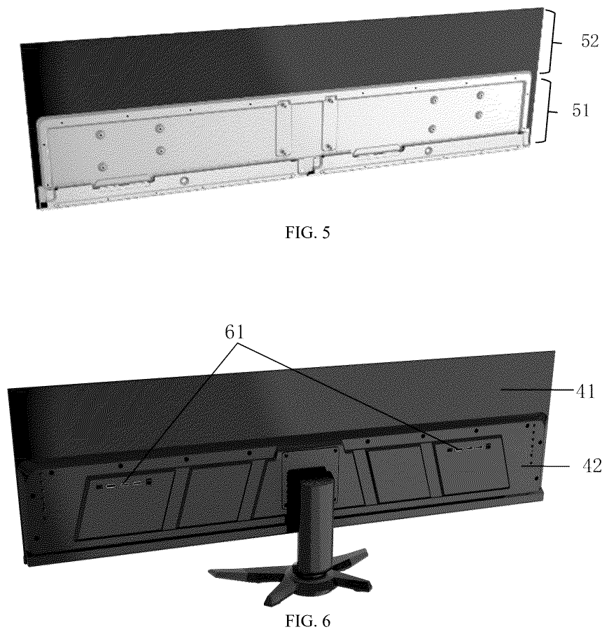

In some embodiments, as shown in FIG. 4a to FIG. 4d, the display module further includes a back plate 41 disposed at a side of the middle frame 12 away from the display panel 11. As shown in FIG. 5, a surface of the back plate 41 away from the display panel 11 includes a functional region 51 and a non-functional region 52. Here, the functional region corresponds to the location where the system-on-chip (SoC) of the display is located. FIG. 4a shows a schematic view of a cross-sectional structure of a left-side frame of the display module, FIG. 4b shows a schematic view of a cross-sectional structure of a right-side frame of the display module, FIG. 4c shows a schematic view of a cross-sectional structure of an upper-side frame of the display module, and FIG. 4d shows a schematic view of a cross-sectional structure of a lower-side frame of the display module.

Exemplarily, the back plate 41 may be made by using 0.8 T electro-galvanized steel sheets, which is not limited by the present application.

Exemplarily, the side surfaces of the back plate 41 can be snap-fitted and connected to the frame structure 31 of the middle frame 12 via a snap-fit method (as shown in FIG. 4c).

Exemplarily, as shown in FIG. 4a to FIG. 4d, the surface of the frame structure 31 away from the display panel 11 may be designed as a dual-curved shape to improve the appearance effect.

Referring to FIG. 5, a back image of a back plate is exemplarily shown. As shown in FIG. 5, the functional region 51 is located at a lower half of the back plate 41, and the non-functional region 52 is at an upper half of the back plate 41.

Exemplarily, as shown in FIG. 5, the display module further includes an insulation protection layer located in the non-functional region 52 and not overlapping with the functional region 51. The insulation protection layer may be, for example, a spray paint, such as the black paint shown in FIG. 5. By partially shielding and spraying the surface of the back plate 41 away from the display panel 11, screw holes and other parts in the functional region 51 are unpainted, it is ensured that the rear cover 42 and the back plate 41 fully contact and well grounding after being locked and attached to the back plate 41 via screws, so that grounding resistance can be reduced as much as possible, and electromagnetic shielding performance is better.

In some embodiments, as shown in FIG. 4d, the display module further includes a rear cover 42 located at the side of the functional region 51 away from the plurality of display panels 11. An accommodating space is disposed between the rear cover 42 and the functional region 51, and the accommodating space is configured to dispose at least one of: a card (e.g., the printed circuit board (PCB) shown in FIG. 4a to FIG. 4d), a system on chip, and a connecting structure (e.g., screw holes).

Referring to FIG. 6, a back image of a display module is exemplarily shown. As shown in FIG. 6, the rear shell 42 is the protruding part relative to the back plate 41. The rear shell 42 only covers the functional region 51 located at the lower half of the back plate 41, and does not cover the non-functional region 52 located at the upper half of the back plate 41. In this way, the thickness of the module (for example, the thickness of the main body is less than or equal to 6 mm, such as 5.85 mm) can be further reduced, the weight of the module is reduced, and the portability of the module is improved.

Exemplarily, the rear cover 42 may be made by using 0.8T electro-galvanized steel sheets. The rear cover 42 is locked and attached to the back plate 41 via screws and is configured to shield components such as the card (e.g., PCB shown in FIG. 4a to FIG. 4d), card cover (e.g., the cover (CV) shown in FIG. 4a to FIG. 4d), system-on-chip, and connecting structures (e.g., screw holes). The rear cover 42 also plays a role in electromagnetic shielding.

In some embodiments, as shown in FIG. 6, the rear cover 42 is provided with interfaces 61, the interfaces 61 include at least one of the following: a power interface, a video interface, an earphone interface and other user interfaces.

In some embodiments, as shown in FIG. 4a to FIG. 4d, the display module further includes a chip on film (COF) connected to a bonding region of each of the plurality of the display panels 11, and a front frame 43 disposed close to the light-emitting surfaces of the plurality of display panels 11. An orthographic projection of the front frame 43 on the plurality of display panels 11 covers an orthographic projection of the COF on the plurality of display panels 11.

By placing the front frame 43 at the COF side, the COF may be shielded to prevent the COF from exposure.

Exemplarily, as shown in FIG. 8, both the COF and the front frame 43 are located at the lower frame of the display module.

Exemplarily, the front frame 43 may be made of plastic materials such as polycarbonate, and can also be made of metal materials. Plastic material can be used to reduce the risk of the display panel 11 being compressed.

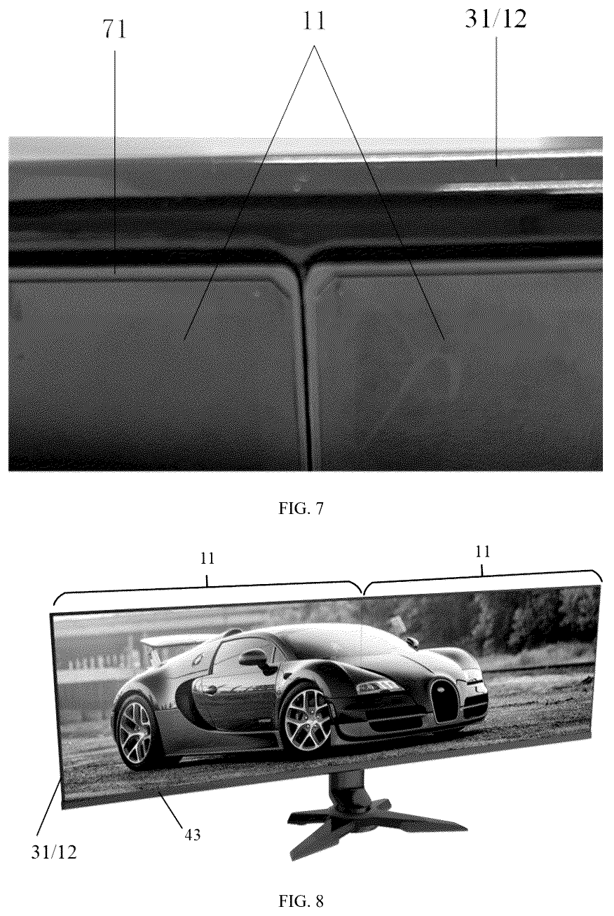

In some embodiments, as shown in FIG. 7, the display panel 11 is a borderless display panel. In this way, the width of the non-display region NA between the two adjacent display regions AA can be reduced, and the sense of fragmentation in the picture is further minimized.

In some embodiments, as shown in FIG. 7, the edges of the display panel 11 are coated with a black adhesive 71. In this way, backlight leakage at the edges of the display panels 11 can be reduced, the product appearance is improved, and the realization of borderless and thin design is facilitated.

In order to make black adhesive 71 at the edges smoother and more uniform, the edges of the display panel 11 may undergo grinding and chamfering (as shown in FIG. 7).

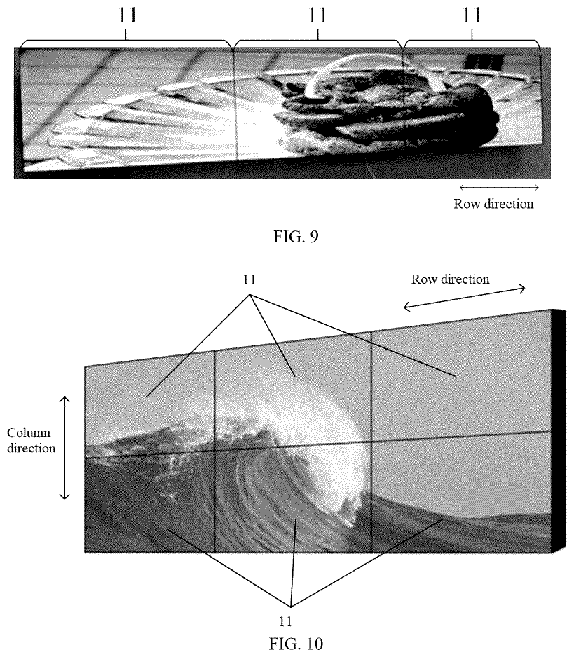

In some embodiments, the display module may include two or more tightly spliced display panels 11. For example, FIG. 8 shows a display module including two tightly spliced display panels 11, FIG. 9 shows a display module including three display panels 11 tightly arranged in a direction (such as a row direction shown in FIG. 9), and FIG. 10 shows a display module including six display panels 11 tightly arranged in a row direction and a column direction.

A display device is further provided by the present application, the display device includes: the display module as provided in any one of the embodiments stated above; and a driving component connected to the plurality of display panels to provide driving signals to the plurality of display panels.

A person skilled in the art may understand that the display device provided in the present application has the advantages of the aforementioned display module. The display device provided in the present application can be integrated into products such as laptops and monitors, serving as a display in various fields such as vehicle-mounted displays and consumer electronics.

In the present application, the meaning of “plurality of” is “two or more”, and the meaning of “at least one” is “one or more”, unless explicitly and particularly defined otherwise.

In the present application, the terms that indicate orientation or position relations, such as “upper” and “lower”, are based on the orientation or position relations shown in the drawings, and are merely for conveniently describing the present application and simplifying the description, rather than indicating or implying that the device or element must have the specific orientation and be constructed and operated according to the specific orientation. Therefore, they should not be construed as a limitation on the present application.

In the present text, the terms “include”, “contain” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “including a . . . ” does not exclude additional same element in the process, method, article or device including the element.

The “one embodiment”, “some embodiments”, “exemplary embodiments”, “one or more embodiments”, “example”, “one example” or “some examples” as used herein are intended to indicate that specific features, structures, materials or characteristics related to the embodiment or example are included in at least one embodiment or example of the present application. The schematic indication of the above terms does not necessarily refer to the same one embodiment or example. Moreover, the specific features, structures, materials or characteristics may be included in any one or more embodiments or examples in any suitable manner.

In the present text, relation terms such as first and second are merely used to distinguish one entity or operation from another entity or operation, and that does not necessarily require or imply that those entities or operations have therebetween any such actual relation or order.

In the description on some embodiments, “couple” and “connect” may be used. For example, in the description on some embodiments, the term “connect” may be used to indicate that two or more components directly physically contact or electrically contact each other. As another example, in the description on some embodiments, the term “couple” may be used to indicate that two or more components directly physically contact or electrically contact each other. However, the term “couple” or “communicatively couple” may also indicate that two or more components do not directly contact each other, but still cooperate with each other or act on each other. The embodiments disclosed herein are not necessarily limited by the contents herein.

“At least one of A, B and C” and “at least one of A, B or C” have the same meaning, and both of them include the following combinations of A, B and C: solely A, solely B, solely C, the combination of A and B, the combination of A and C, the combination of B and C, and the combination of A, B and C.

“A and/or B” include the following three combinations: solely A, solely B, and the combination of A and B.

As used herein, with reference to the context, the term “if” is optionally interpreted as meaning “when” or “in response to determining that” or “in response to detecting that”. Similarly, with reference to the context, the phrase “if it has been determined that” or “if the stated condition or event has been detected” is optionally interpreted as referring to “when it has been determined that” or “in response to determining ...” or “when the stated condition or event has been detected” or “in response to the stated condition or event having been detected”.

The “for” or “configured for” as used herein is intended as opened and inclusive languages, and does not exclude apparatuses adapted for or configured for executing additional tasks or steps.

The “based on” or “according to” as used herein means opening and inclusive. The processes, steps, calculations or other actions based on one or more conditions or values may be based on other conditions or exceed the values in practice. The processes, steps, calculations or other actions according to one or more conditions or values may be according to other conditions or exceed the values in practice.

As used herein, “about”, “substantially” or “approximately” includes the described value and the average value within an acceptable deviation range of the particular value, wherein the acceptable deviation range is decided by the discussed measurement that a person skilled in the art has taken into consideration and the error relevant to the measurement on the specific quantity (i.e., the limitation of the measuring system).

As used herein, “parallel”, “perpendicular”, “equal” and “flushing” include the described case and cases similar to the described case, wherein the range of the similar cases is within an acceptable deviation range, wherein the acceptable deviation range is decided by the discussed measurement that a person skilled in the art has taken into consideration and the error relevant to the measurement on the specific quantity (i.e., the limitation of the measuring system). For example, “parallel” includes absolute parallelism and approximate parallelism, wherein the acceptable deviation range of the approximate parallelism may, for example, be deviations within 5°. “Perpendicular” includes absolute perpendicularity and approximate perpendicularity, wherein the acceptable deviation range of the approximate perpendicularity may also, for example, be deviations within 5°. “Equal” includes absolute equality and approximate equality, wherein the acceptable deviation range of the approximate equality may, for example, be that the difference between the two equal instances is less than or equal to 5% of any one of them. “Flushing” includes absolute flushing and approximate flushing, wherein the acceptable deviation range of the approximate flushing may, for example, be that the distance between the two flushing instances is less than or equal to 5% of the dimension of any one of them.

It should be understood that, when a layer or element is described as on another layer or a base board, the layer or element may be directly on another layer or the base board, or an intermediate layer may also exist between the layer or element and another layer or the base board.

The exemplary embodiments are described herein with reference to sectional views and/or plan views as idealized illustrative figures. In the drawings, in order for clarity, the thicknesses of the layers and the regions are exaggerated. Therefore, alterations from the shapes of the figures as the result of, for example, fabricating techniques and/or tolerances can be envisaged. Therefore, the exemplary embodiments should not be interpreted as limited to the shapes of the regions shown herein, but should include the shape deviations caused by, for example, fabrication. For example, an etching region illustrated as rectangular generally has a curved feature. Therefore, the regions shown in the drawings are essentially illustrative, and their shapes are not intended to illustrate the practical shapes of the regions of the device, and are not intended to limit the scopes of the exemplary embodiments.

Finally, it should be noted that the above embodiments are merely intended to explain the technical solutions of the present application, and not to limit them. Although the present application is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present application.

1. A display module, comprising:
a plurality of display panels, the plurality of display panels being tightly spliced; and
a middle frame disposed away from light-emitting surfaces of the plurality of display panels;
wherein the plurality of display panels are fixedly connected to a same middle frame.

2. The display module according to claim 1, wherein the middle frame comprises:
a support structure located at a splicing gap between two adjacent display panels, wherein a side of the support structure close to the two adjacent display panels is fixedly connected to the two adjacent display panels, respectively;
the display module further comprises at least one of:
an optical film located at a side of the middle frame away from the two adjacent display panels; and
a light guide plate located at a side of the optical film away from the two adjacent display panels.

3. The display module according to claim 2, wherein the support structure comprises:
a first support structure comprising a first support plate and a second support plate, wherein the first support plate is disposed close to the two adjacent display panels, the second support plate is connected to a side surface of the first support plate away from the two adjacent display panels, and in an arrangement direction of the two adjacent display panels, the second support plate is centrally disposed on the first support plate, and the first support plate and the second support plate are perpendicular to each other.

4. The display module according to claim 3, wherein the optical film is provided with an opening, and an orthographic projection of the second support plate on a plane where the optical film is located is located within a region of the opening, so that the opening is configured to avoid the second support plate.

5. The display module according to claim 4, wherein in the arrangement direction of the two adjacent display panels, a first gap is disposed between the second support plate and a hole wall of the opening.

6. The display module according to claim 4, wherein in a normal direction of the plurality of display panels, a second gap is disposed between the second support plate and the light guide plate;
an orthographic projection of the first support plate on the plane where the optical film is located overlaps with the optical film, and in the normal direction of the plurality of display panels, a third gap is disposed between the first support plate and the optical film;
wherein the second gap is less than or equal to the third gap.

7. The display module according to claim 3, wherein in an extending direction of the splicing gap, the support structure comprises a plurality of first support structures spaced apart from each other.

8. The display module according to claim 3, wherein the support structure further comprises:
a second support structure comprising a third support plate, wherein the third support plate is parallel to and connected to the first support plate; and
in an extending direction of the splicing gap, the second support structure is located at two sides of the first support structure.

9. The display module according to claim 8, wherein in a normal direction of the plurality of display panels, a thickness of the third support plate is the same as a thickness of the first support plate; and
in the arrangement direction of the two adjacent display panels, a width of the third support plate is the same as a width of the first support plate.

10. The display module according to claim 2, wherein each of the plurality of display panels comprises a display region and a non-display region located at at least one side of the display region, and an orthographic projection of the support structure on the display panel does not overlap with the display region; and
in an arrangement direction of the two adjacent display panels, a fifth gap is disposed between the orthographic projection of the support structure on the display panel and the display region.

11. The display module according to claim 2, wherein the display module further comprises:
a polarizer located at a side of the two adjacent display panels close to the support structure, wherein in a normal direction of the plurality of display panels, a sixth gap is disposed between the polarizer and the optical film, and the sixth gap is greater than or equal to 1.0 mm.

12. The display module according to claim 2, wherein the display module further comprises:
a polarizer located at a side of the two adjacent display panels close to the support structure, wherein an orthographic projection of the polarizer on the two adjacent display panels and an orthographic projection of the support structure on the two adjacent display panels have an overlapping region; and
an edge of a side surface of the support structure close to the two adjacent display panels is provided with a concave platform, the concave platform is recessed away from the polarizer, wherein in an arrangement direction of the two adjacent display panels, a width of the concave platform is greater than a width of the overlapping region, and in a normal direction of the plurality of display panels, a height of the concave platform is greater than or equal to a thickness of the polarizer.

13. The display module according to claim 2, wherein the middle frame further comprises:
a frame structure located around the support structure and the plurality of display panels, wherein the frame structure and the support structure are an interconnected integrated structure.

14. The display module according to claim 13, wherein the frame structure comprises a first frame structure and a second frame structure located at different sides of the support structure, and the display module further comprises:
a first light-shielding tape adhered between the first frame structure and the two adjacent display panels;
a second light-shielding tape adhered between the second frame structure and the two adjacent display panels;
a third light-shielding tape adhered between the support structure and the two adjacent display panels;
wherein a width of the third light-shielding tape is greater than or equal to a width of the second light-shielding tape, and the width of the second light-shielding tape is greater than or equal to a width of the first light-shielding tape.

15. The display module according to claim 1, wherein the display module further comprises at least one of:
a back plate disposed at a side of the middle frame away from the plurality of display panels, wherein a surface of the back plate away from the plurality of display panels comprises a functional region and a non-functional region;
a rear cover located at a side of the functional region away from the plurality of display panels, wherein an accommodating space is disposed between the rear cover and the functional region, and the accommodating space is configured to dispose at least one of: a card, a system on chip, and a connecting structure; and
an insulation protection layer located in the non-functional region and not overlapping with the functional region.

16. The display module according to claim 1, wherein the display module further comprises:
a chip on film connected to a bonding region of each of the plurality of display panels; and
a front frame disposed close to the light-emitting surfaces of the plurality of display panels, wherein an orthographic projection of the front frame on the plurality of display panels covers an orthographic projection of the chip on film on the plurality of display panels.

17. The display module according to claim 1, wherein each of the plurality of display panels is a borderless display panel, and edges of the display panel are coated with a black adhesive.

18. The display module according to claim 9, wherein the first support plate, the second support plate, and the third support plate are of an integrated structure.

19. A display device, comprising:
the display module according to claim 1; and
a driving component connected to the plurality of display panels and configured to provide driving signals to the plurality of display panels.

20. The display device according to claim 19, wherein the middle frame comprises:
a support structure located at a splicing gap between two adjacent display panels, wherein a side of the support structure close to the two adjacent display panels is fixedly connected to the two adjacent display panels, respectively;
the display module further comprises at least one of:
an optical film located at a side of the middle frame away from the two adjacent display panels; and
a light guide plate located at a side of the optical film away from the two adjacent display panels.
